(19) United States
(12) Patent Application Publication
(10) Pub. No.: US 2026/0166945 A1
(43) Pub. Date: Jun. 18, 2026

(54) CONTAINER AND MODULE FOR A TEMPERATURE CONTROL MEDIUM CIRCUIT

(71) Applicant: TI Automotive Technology Center GmbH, Rastatt (DE)

(72) Inventors: Irfan KIZILAY, Reilingen (DE); Manuel Lindow, Gernsbach (DE); Stefan Leipold, Seltz (FR); Stefan Schwab, Pfinztal (DE); Florian Deibel, Sinzheim (DE)

(21) Appl. No.: 19/417,906

(22) Filed: Dec. 12, 2025

(30) Foreign Application Priority Data
Dec. 12, 2024 (DE) 102024137453.5

(51) Int. Cl. B60H 1/00

(52) U.S. Cl. CPC B60H 1/00392; B60H 1/00328

(57) ABSTRACT

A container for a module of a temperature control medium circuit has a container wall. The container wall encloses a container lumen that can be filled with the temperature control medium. The container has an inner element, wherein the inner element is at least partially enclosed by the container wall or is arranged in the container lumen. A module for a temperature control medium circuit comprises a container and a carrier. The container has a container wall, wherein the container wall encloses a container lumen that can be filled with the temperature control medium. The carrier has at least one channel and at least one receptacle for arranging at least one fluid component. The carrier comprises a central part, a first side part, and a second side part. The container has the central part, the first side part, and/or the second side part.

### RELATED APPLICATIONS

The present disclosure claims priority to and the benefit of German Application 102024137453.5, filed on Dec. 12, 2024, the entire contents of each of which are incorporated herein by reference.

### FIELD

The present disclosure relates to a container for a module of a temperature control medium circuit, wherein the container wall encloses a container lumen that can be filled with the temperature control medium, and a carrier that has at least one channel and at least one receptacle for arranging fluid components.

### BACKGROUND

Such generic modules for a temperature control medium circuit with a container and a carrier are known, for example, from EP 4 279 300 A1 and are primarily used for temperature control of drive batteries in electric vehicles. The carrier of the known module comprises a plurality of more or less parallel channels which connect the various fluid components (pumps, heat exchangers, valves) of the module or the entire temperature control system (e.g., fluid lines on the drive battery and thus outside the module) with each other. The fluid components of the module are attached to a receptacle on the carrier and are supported by it. The container is also mechanically and fluidically connected to the carrier so that the container supplies the rest of the module and the entire temperature control system with temperature control medium. The module is the result of the concentration of fluid components, saving on flow paths and installation space and making maintenance and repair work somewhat easier.

Modules are known in practice that have a container with a filler opening and an overflow tube. The overflow tube opens with a first end into an upper section of the container wall and is connected with a second end to another element of the module or the temperature control medium circuit. Excess temperature control medium in the temperature control medium circuit, for example due to thermal expansion of the temperature control medium or a parking situation of the vehicle, can be returned from the other element to the container with the aid of the overflow tube, thereby avoiding overpressure conditions in particular. Under pressure conditions, on the other hand, are avoided by the container because it provides a reservoir of temperature control medium. This allows a compensatory amount of temperature control medium to be fed into the temperature control system or fluid circuit as required, so that the container acts as a compensation tank or buffer.

In general, the containers or modules known from practice and the literature are complex to manufacture (molding processes and assembly).

### BRIEF SUMMARY

The present disclosure reduces the manufacturing costs for a temperature control medium circuit with a container and a carrier.

In one form, the present disclosure provides a container for a module of a temperature control medium circuit, wherein the container has a container wall, wherein the container wall encloses a container lumen that can be filled with the temperature control medium, characterized in that the container has an inner element, wherein the inner element is at least partially enclosed by the container wall or is arranged in the container lumen.

We have discovered that inner elements shift the effort from assembly more towards the molding process. Assembly often requires complex movements, making automation correspondingly labor-intensive and costly.

It was found that the increased complexity of the container or module structures also causes greater effort in the forming process. In particular, the present disclosure has found that the effort saved in assembly by the inner element is greater than the additional effort required in the forming process due to the inner element. As a result, the difficulties mentioned at the outset are overcome.

It is preferable that no external tube or hose leads from an element of the module, assembly, or temperature control medium circuit into an upper area of the container. The container is preferably designed so that the inner element or an outer side of the inner element is or can be brought into contact with the temperature control medium. It is possible that at least a section of an inner side of the inner element is or can be brought into contact with the temperature control medium. It is preferable that the inner element protrudes from the container. It is very advantageous that the inner element is part of a/the center part. Advantageously, the inner element is connected in one piece to a section of the center part of a/the carrier and is preferably an integral part of the center part.

The term “top” preferably refers to the intended arrangement of the container in a vehicle. It is highly preferred that the container has a container lid or a filler opening. It is highly preferred that the container lid or filler opening defines/define an upper end of the container. It is preferred that the container comprises a container base. The container base is preferably arranged opposite the container lid or filler opening. The container base comprises an area of the container where the temperature control medium is most likely to remain.

According to a preferred embodiment, the inner element comprises a tube, wherein the tube preferably has a free end. This allows the temperature control medium to be returned from the temperature control medium circuit back into the container. It is advantageous for the free end of the tube to open into the upper two-thirds, the upper half, or the upper third of the container lumen. It is highly preferred that the tube comprises a connected end. The connected end of the tube is preferably the lower end of the tube. The connected end of the tube is advantageously connected to the container wall. It is highly preferred that the tube or the connected end of the tube is connected to the container base and preferably passes through the container base. The tube is advantageously designed as an overflow tube. The tube of the inner element means that external tubes for returning temperature control medium to the container are no longer necessary. External tubes require separate connections, which necessitate connectors with large tolerance requirements for the purpose of tightness. These large tolerance requirements of the connectors and the external installation cause a large manufacturing effort, which is avoided by the tube of the inner element. The tube of the inner element allows the temperature control medium to flow back from the module or from the temperature control medium circuit back into the container. This can occur in certain parking situations or in the event of overpressure due to an increase in the temperature of the temperature control medium.

It is preferable that the inner element is designed in such a way that the free end of the tube is supported. It is particularly preferable that the tube is supported at least at one additional point in addition to the container wall or container base, in particular at a partition wall. This results in greater stability of the tube, as the free end would otherwise be very exposed to the movements of the temperature control medium in the container.

Preferably, the inner element or the container comprises at least one partition wall, wherein the partition wall divides the container lumen into at least two container chambers, wherein the container chambers are preferably fluidically connected to each other. This reduces the movement of the temperature control medium in the container, thereby reducing, in particular, the sloshing of the temperature control medium. It is preferable that the inner element comprises at least 2, 3, or 4 partition walls. Advantageously, the container comprises at least 4, 6, 8, or 12 container chambers.

It is particularly preferred that the at least one partition wall or the partition walls are connected to the tube, preferably in one piece and in particular integrally. It is preferred that at least two of the partition walls are connected to each other in one piece or integrally. It is preferred that the at least one partition wall is connected to the center part or carrier in one piece or integrally. It is particularly advantageous if the inner element or at least one partition wall is supported at least one and in particular at least two points in the height direction between the container base and the container lid or the filler opening on the container wall or is connected to the container wall.

It is preferable that the container comprises a filler neck. The filler neck preferably protrudes at least in sections into the container lumen. The filler neck enables particularly drip-proof filling of the container. It is advantageous that a section of the filler neck protrudes out of the container lumen defined by the container wall. Conveniently, the filler neck comprises a fastening means and, in particular, a thread for fastening a/the container lid. It is preferable that the filler neck defines the filler opening. Advantageously, the container wall comprises a recess for inserting the filler neck. It is possible that the filler neck is connected to the tube and/or the at least one partition wall-preferably in one piece and in particular integrally.

It is preferred that the inner element comprises a holder for a level sensor. Advantageously, the holder for the level sensor is connected to the tube or at least one of the partition walls or to a/the center part or a/the carrier-preferably in one piece and in particular integrally. It is preferable that the holder for the level sensor is connected to the container wall and in particular protrudes through the container wall.

The difficulties mentioned at the outset are overcome by a module for a temperature control medium circuit, wherein the module comprises a container—in particular a container according to the present disclosure—and a carrier, wherein the container has a container wall, wherein the container wall encloses a container lumen that can be filled with the temperature control medium, wherein the carrier has at least one channel and preferably several channels, wherein the carrier comprises at least one receptacle for arranging at least one fluid component, wherein the carrier has a center part, a first side part, and a second side part, characterized in that the container comprises the center part, the first side part, and/or the second side part.

The present disclosure is based on the discovery that the three parts of the carrier lead to greater structural flexibility. This is because three parts (center part, first side part, second side part) allow channels to be provided on both sides of the carrier, which can also be connected to each other by means of breakthroughs in the center part. This allows the carrier or module as a whole to be designed more compactly, which is advantageous in terms of the installation space in a vehicle.

It was found that extending at least one part (center part, first side part, and/or second side part) of the carrier into the container makes the molding process for this part more complex. On the other hand, however, this eliminates the need for assembly work. In particular, the present disclosure is based on the realization that the effort saved in assembly is greater than the additional effort required in the forming process. As a result, the task mentioned at the outset was solved.

The term “fluid component” preferably refers to components that serve to guide and/or influence fluids, including, for example, pumps, heat exchangers, and/or valves and the like. The term “receptacle” preferably refers to a location on the carrier intended for a specific fluid component, whereby the intended location preferably provides at least one fluid connection and/or at least one mechanical connection for the fluid component.

The center part is preferably arranged at least in sections between the first side part and the second side part. The center part, the first side part, and the second side part preferably form a base body. Conveniently, the center part and/or the first side part and/or the second side part comprise a plastic. It is particularly preferable that the center part is connected to the first side part and/or to the second side part, preferably in a material-locking manner and in particular by means of welding and, especially preferably, welding produced by blow molding.

It is advantageous that the module or carrier comprises at least one connector and preferably several connectors. The connector or connectors are preferably designed as plug element(s) and in particular as male plug element(s). The geometry of the connector or connectors advantageously complies with a standard, in particular a VDA standard. It is preferable that the connector or connectors is/are connected to the base body or the center part or the first side part or the second side part-preferably in a material-locking manner and in particular by means of welding.

According to a preferred embodiment, the center part is designed as a single piece and preferably integrally. The center part is preferably manufactured by injection molding. This means that a large number of structures can be realized in the center part in a single injection molding step, which keeps manufacturing costs low. Injection molding allows the two sides of the center part to be structured independently of each other. In particular, injection molding does not require a first side of the injection-molded element to follow a second side of the manufactured element facing away from the first side, as is the case with blow molding or rotational molding. The module may comprise a metallic body. It is possible for the metallic body to be embedded in the center part, which is preferably injection molded. The metallic body may, for example, serve a heat exchange function.

It is advantageous that the center part is flat and has a first lateral surface and a second lateral surface. Preferably, the center part comprises several end faces. The end faces preferably form a closed circumference which defines the first lateral surface and the second lateral surface. It is preferable that the first lateral surface is intended to face the heat exchanger. It is preferable that the second lateral surface of the center part is designed to face the pump(s). It is preferable that the first lateral surface faces the first side part or is connected to the first side part, in particular by a material bond and preferably by welding, preferably produced by blow molding. It is preferable that the second lateral surface of the center part faces the second side part and is preferably connected to the second side part, in particular by a material bond and preferably by welding, preferably produced by blow molding. It is highly preferred that the first side part and the second side part are at least partially adjacent to each other and preferably connected to each other, in particular by means of a material bond and preferably by means of welding, preferably produced by blow molding. It is possible that the center part has exceptions, preferably located at an edge of the center part, which preferably allow direct contact between the first side part and the second side part.

Advantageously, the center part or the first lateral surface or the second lateral surface of the center part comprises at least one channel contour. The at least one channel contour is preferably formed as an edge or weld seam projecting from the first lateral surface or second lateral surface. The at least one channel contour or protruding edge serves to melt and bond with the first side part or second side part. After melting or blow molding, at least part of the protruding edge can be converted into a weld seam, as seen in the cross-section of the channel contour.

It is particularly preferable that the first side part and/or the second side part are formed in one piece and preferably integrally. It is advantageous that the first side part and/or the second side part are produced by blow molding, in particular simultaneously. This results in a particularly low-cost production of a side part or the side parts. This is because the side parts can be designed in such a way that they essentially correspond to a single—complex—shell, in which the inner surface essentially follows the outer surface, with the outer surface itself being determined by the molding tool.

It is preferred that the first side part and/or the second side part extend into the container. Preferably, the first side part and/or the second side part (in each case) form at least part of the container or the container wall. Advantageously, the first side part and/or the second side part extends up to a recess for a filler opening or for a filler neck or up to a filler opening. It is particularly advantageous if the first side part and the second side part at least partially enclose the center part in a section of the container. It is particularly preferred that the first side part and the second side part at least partially enclose one/the inner element of the container. It is preferred that the first side part forms a first container shell. Advantageously, the second side part forms a second container shell. The first container shell and the second container shell preferably form at least part of the container wall.

It is advantageous that the first side part and/or the second side part at least partially form at least one channel and/or at least one receptacle. Conveniently, the first side part and the center part together form at least one channel and/or at least one receptacle, which is assigned to the first side of the module. It is advantageous for the second side part and the center part to form at least one channel and/or at least one receptacle, which is assigned to the second side of the module. It is particularly preferred that a section of the container wall of the first side of the module or the first container shell is connected in one piece and preferably integrally with a section or a receptacle or a channel of the first side part of the carrier. It is particularly preferred that a section of the container wall of the second side of the module or the second container shell is connected in one piece and preferably integrally to a section or a receptacle or a channel of the first side part of the carrier.

It is particularly preferred that the center part comprises at least one section of one/the inner element of the container. This has the effect of concentrating the complexity of the elements on the center part, so that all the functions of the inner element and the center part of the carrier are combined in a single element by means of a single injection molding process. This ultimately allows a robust and, above all, compact design of the module. The inner element is advantageously at least partially enclosed by the container wall or the first container shell or the second container shell. It is preferred that the inner element is arranged in the container lumen. Preferably, the center part—especially in the area of the carrier—comprises at least one structure for forming a channel and/or a receptacle. It is particularly preferred that the inner element of the container is connected in one piece and preferably integrally with one/the center part of the carrier.

Advantageously, the center part comprises at least part of a receptacle and/or at least one cross-sectional portion of a channel. It is very preferred that the center part has at least one channel contour. The channel contour is preferably formed as an edge or weld seam projecting from a surface or the first lateral surface and/or the second lateral surface of the center part. The channel contour is preferably designed so that the center part forms a channel when joined to the first side part and/or the second side part. The channel contour is preferably designed such that it is melted—preferably during blow molding of the first side part and/or second side part—and forms a material bond and, in particular, a weld seam when joined with the first side part and/or the second side part.

It is preferred that the center part has a container base contour on the first side and/or second side. The container base contour can be designed as an edge or weld seam protruding from a surface or the first lateral surface and/or the second lateral surface of the center part. The container base contour is preferably designed to form a weld seam during a welding process, and in particular during blow molding of the first side part and/or second side part. It is preferable that the first side part and/or the second side part form or have formed a material bond with the center part at the location of the container base contour of the first lateral surface or second lateral surface and, in particular, form a weld seam, preferably due to the blow molding of the first side part and/or the second side part.

The task mentioned at the outset is solved by an assembly for a temperature control medium circuit, comprising a module according to the present disclosure, wherein at least one fluid component is arranged on the carrier of the module. This causes a concentration of the fluid components on the module for easier maintenance or repair and, as a result, enables greater compactness of the module.

The task mentioned at the outset is solved by a use of a container, module, or assembly according to the present disclosure for an electrical system and preferably a vehicle—in particular for an electric vehicle—and/or for an immobile electrical device, in particular for a charging point, preferably for a drive battery of a vehicle or electric vehicle and/or for a power electrical component of a stationary device or charging point. This means that, due to the compactness of the module or assembly, slightly more space is available in the vehicle or in the stationary electrical device for other components.

The task mentioned at the beginning is solved by a method for manufacturing a module for a temperature control medium circuit, in particular a module according to the present disclosure, wherein the module comprises a container—preferably a container according to the present disclosure—and a carrier, wherein the module or the container and/or the carrier has a center part, a first side part and a second side part, wherein the center part is arranged at least in sections between the first side part and the second side part, characterized in that the first side part and/or the second side part is/are manufactured by blow molding.

The present disclosure is based on the discovery that blow molding enables particularly low-cost production of a side part or side parts. This produces an entire side wall or two side walls in a single manufacturing process.

Conveniently, the container comprises a container wall, wherein the container wall preferably includes a container lumen that can be filled with the temperature control medium. Preferably, the carrier has at least one channel and/or at least one receptacle for arranging at least one fluid component. Advantageously, the container comprises an inner element, wherein the inner element is preferably at least partially enclosed by the container wall or arranged in the container lumen.

It is preferred that the first side part and the second side part are produced simultaneously by blow molding or in a common blow molding tool. This allows for particularly cost-effective blow molding tools because two parts are created simultaneously with one blow molding tool.

According to a particularly preferred embodiment, the center part is arranged between the first side part and the second side part during the blow molding of the first side part and/or the second side part. This not only allows the side parts to be produced at low cost, but also allows the center part and one of the side parts or the side parts to be adapted to each other simultaneously.

It is particularly preferable for the center part to be connected or welded to the first side part and/or the second side part during the blow molding of the first side part and/or the second side part. In this process, the time and also the process heat of the blow molding are used simultaneously for the material-locking connection or welding of the two or three parts together. The result is a robust, fluid-tight and low-cost module for a temperature control medium circuit.

### BRIEF DESCRIPTION OF THE DRAWINGS

The present disclosure is explained below with reference to an embodiment using six figures. These show in schematic form

FIG. 1 shows a perspective side view of a first side of a module according to the present disclosure,

FIG. 2 shows a center part of the module from FIG. 1 in the perspective from FIG. 1,

FIG. 3 shows the module from FIG. 1 in a perspective side view of a second side of the module,

FIG. 4 shows the center part from FIG. 2 in the perspective view from FIG. 3,

FIG. 5 shows a cross-section through the module from FIGS. 1 and 3 with two cutting planes offset from each other along line L, and

FIG. 6 shows an enlarged view of a section from FIG. 5.

### DETAILED DESCRIPTION

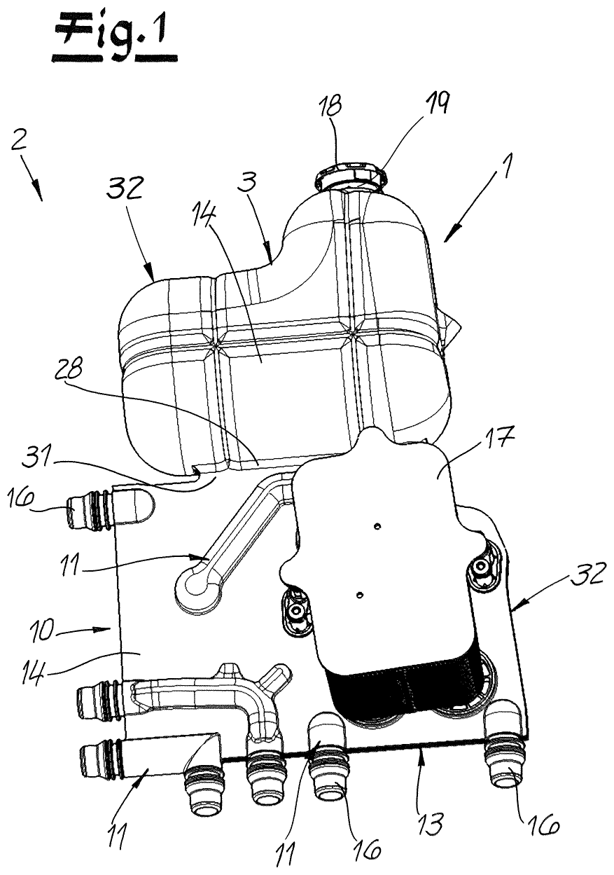

FIG. 1 shows a module 2 according to the present disclosure for arranging fluid components 17, 25. The module 2 comprises a container 1 and a carrier 10, whereby at least one fluid component 17, 25 can be arranged on the carrier 10. A fluid component 17, 25 can be a heat exchanger 17 and/or a pump 25 and/or a valve not shown here. The module 2 forms an assembly with at least one fluid component 17, 25.

In this embodiment, the module 2 or the assembly 2, 17, 25 serves to concentrate fluid components 17, 25 for the compact provision of fluid components 17, 25 for a temperature control medium circuit or a temperature control medium system of a vehicle for the purpose of temperature control of a drive battery. In addition to assembly 2, 17, 25, the temperature control system also comprises fluid lines which lead from assembly 2, 17, 25 to a drive battery not shown here and from there back to assembly 2, 17, 25.

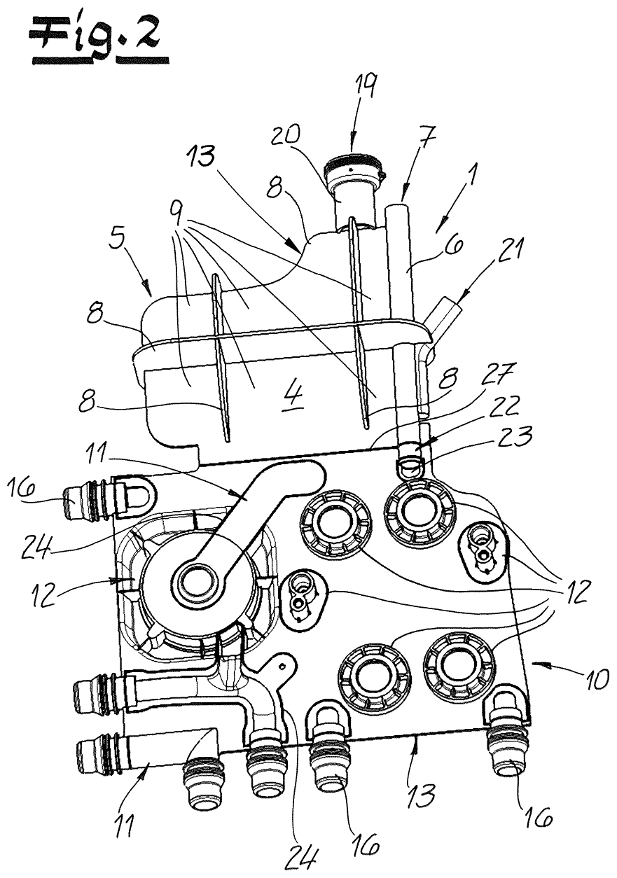

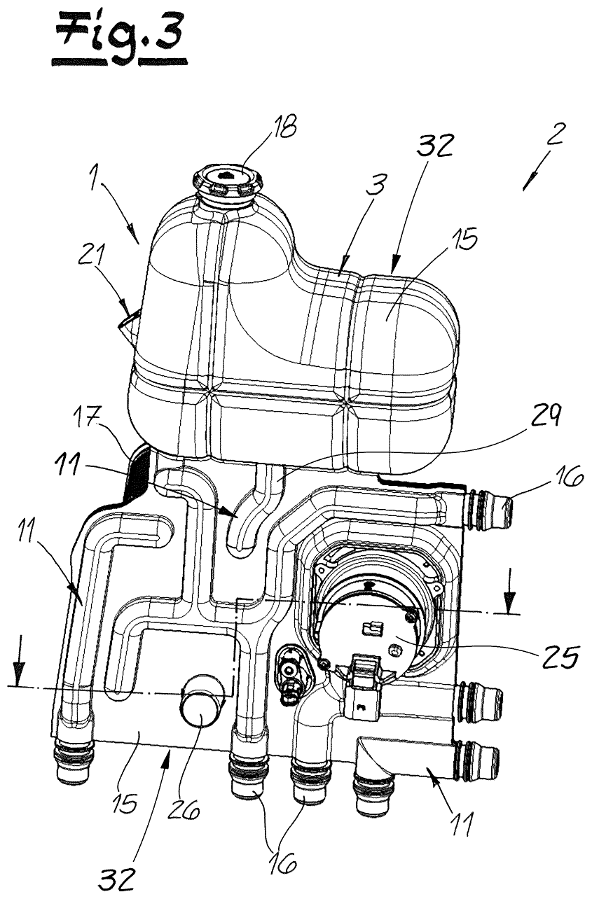

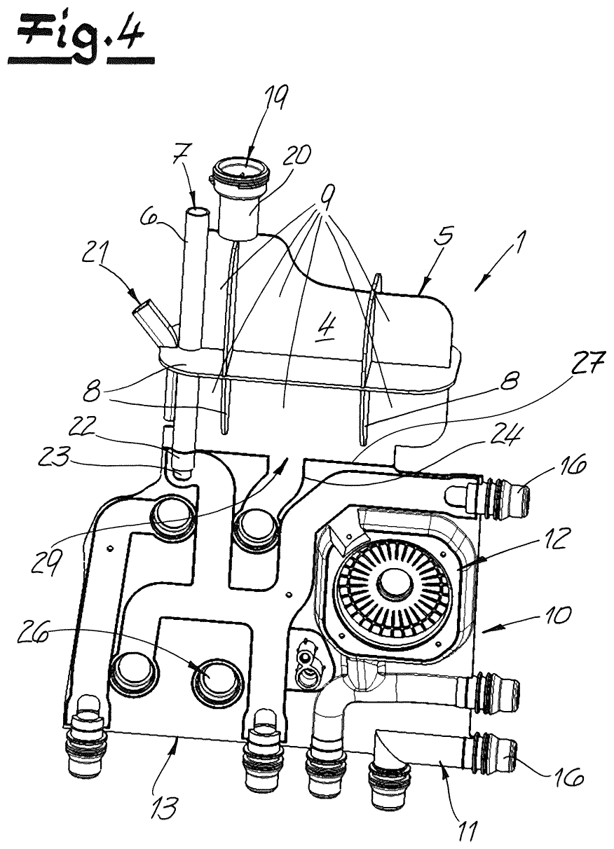

In this embodiment, container 1 is attached to carrier 10. The container 1 comprises a container wall 3 (see FIGS. 1 and 3), which forms a container lumen 4, cf. FIGS. 2 and 4. The container wall 3 preferably comprises a structured surface. The container 1 may have a container lid 18, preferably in an upper section. The container 1 preferably has a filler opening 19, which can preferably be closed or screwed shut with the container lid 18, in particular in a reversible manner.

The container 1 conveniently comprises a container base 28, which is preferably located at an opposite end of the container lid 18. The container base 28 is preferably connected to an upper section 31 of the carrier 10. It is preferable that the carrier 10 or the upper section 31 of the carrier 10 is connected to the container 1 or the container base 28 with an end face.

The carrier 10 comprises at least one channel 11 and at least one receptacle 12, see FIGS. 1 to 4. The receptacles 12 of this embodiment serve to mechanically and fluidically connect the fluid components 17, 25 to the module 2 or the carrier 10. The channels 11 serve to connect the various elements of the module 2 or the assembly 2, 17, 25 fluidically and also serve to connect to external fluid lines not shown here.

It is preferred that the assembly 2, 17, 25 or the module 2 or the carrier 10 comprise at least one connector 16. The connector 16 may be designed as a plug or male plug element and/or comply with the VDA standard. It is highly preferred that the connector(s) 16 of this embodiment be manufactured separately by injection molding.

The carrier 10 is preferably designed as a flat element so that it advantageously has two lateral surfaces and several—preferably four—end surfaces. Conveniently, the surface area of a lateral surface is larger than the surface area of an end face and preferably of all end faces. It is preferred that a receptacle 12 for the heat exchanger 17 is arranged on a first lateral surface of the carrier 10. It is preferred that a receptacle 12 for the pump 25 is located on a second lateral surface of the carrier 10.

It is advantageous that the at least one connector 16 is arranged or welded to one end face and preferably several of the connectors 16 are arranged or welded to one of the end surfaces or to the end surfaces. Preferably, one of the end faces—in particular the uppermost end face—of the carrier 10 is connected to the container 1 or the container base 28.

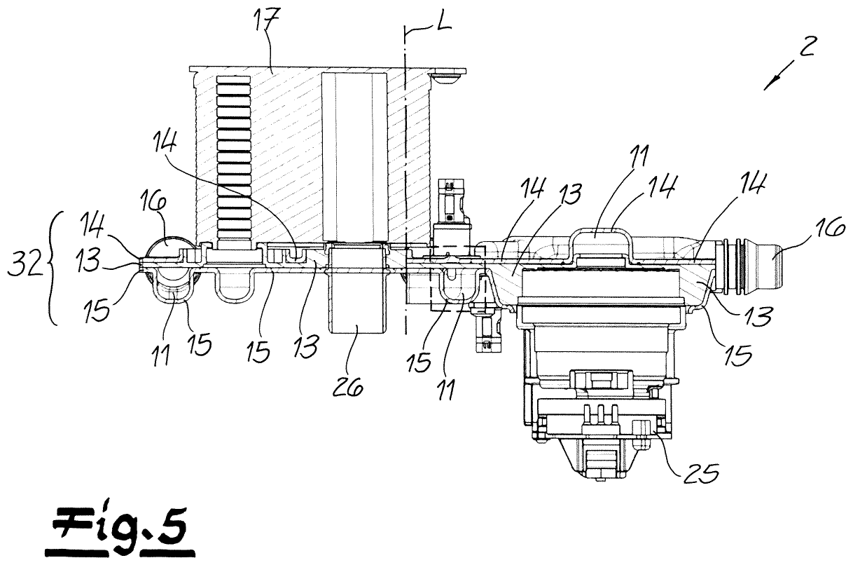

It is preferable that the carrier 10 has a base body 32 and the at least one connector 16. It is preferred that the at least one connector 16 is welded to the center part 13 or to the base body 32. In this embodiment, the carrier 10 or the base body 32 comprises a center part 13, a first side part 14, and a second side part 15, see FIG. 5.

FIG. 1 shows the first side part 14. Conveniently, the first side part 14 comprises the receptacle 12 for arranging the heat exchanger 17 on the carrier 10 or the module 2. It is particularly advantageous that the first side part 14 extends from the carrier 10 to an upper end of the container 1 or to the filler opening 19. The first side part 14 is preferably manufactured by blow molding.

FIG. 2 shows the assembly 2, 17, 25 without the heat exchanger 17 and without the first side part 14, so that the center part 13 of the module 2 is visible. FIG. 2 also omits the second side part 15, which is shown in FIG. 3. The center part 13 preferably extends from the carrier 10 to an upper end of the container 1 or to the filler opening 19. The center part 13 is advantageously manufactured by injection molding.

The center part 13 preferably extends into the container 1 or into the container lumen 4. The container 1 advantageously comprises an inner element 5. The container 1 preferably has a tube 6 and/or at least one partition wall 8 and/or a holder 21 for a level sensor. It is preferred that the inner element 5 comprises the at least one partition wall 8 and/or the filler neck 20 and/or the tube 6 and/or the holder 21.

The tube 6 preferably has a free end 7 and a connected end 22. Preferably, the free end 7 of the tube 6 is the upper end and the connected end 22 is preferably the lower end of the tube 6. It is advantageous that the connected end 22 is connected to the container wall 3 or the container base 28 or the carrier 10. Advantageously, the carrier 10 or the center part 13 comprises a connection element 23 for connecting the connected end 22 of the tube 6.

FIG. 3 shows the second side part 15 and the pump 25. The second side part 15 is preferably manufactured by blow molding. It can be seen that the channels 11 shown in FIG. 3 have, in some cases, completely different courses to the channels 11 shown in FIG. 1. This is made possible by the three-layer structure of the base body 32, which is composed of the center part 13, the first side part 14, and the second part 15. This allows the carrier 10 in particular to be designed very compactly, which is particularly advantageous for vehicles. The second side part 15 is preferably assigned a breakthrough 26, which preferably corresponds to the heat exchanger 17.

Advantageously, the container 1 comprises a container base contour 27, see FIG. 2. The container base contour 27 may be designed as a projection or protruding edge, so that the container base contour 27 facilitates a material bond with the container wall 3 or the first side part 14 or the second side part 15.

It is particularly advantageous for the center part 13 and the first side part 14 and/or the second side part 15 to be connected to each other simultaneously by blow molding the first side part 14 and/or the second side part 15. Advantageously, the center part 13 is arranged in a blow molding tool not shown here. Preferably, a preform of the first side part 14 and/or a preform of the second side part 15 are arranged together with the center part 13 in the blow molding tool. It is expedient to heat and blow the preform of the first side part 14 and/or the preform of the second side part 15 until the desired shape is achieved and the preform or preforms have assumed the shape of the first side part 14 or the second side part 15. It is particularly preferable that the center part 13 or the first side part 14 or the second side part 15 is/are heated and shaped in such a way that a weld seam or weld seams are formed at least in places and preferably on the channel contour 24 or the container base contour 27. It is possible that the center part 13 comprises one channel contour 24 or several channel contours 24, see FIG. 4.

The inner element 5 of this embodiment preferably comprises several partition walls 8, which preferably form ribs standing perpendicular to each other. This restricts the movement of the fluid or temperature control medium in the container 1, so that the sloshing of the fluid is significantly reduced. The partition walls 8 conveniently form container chambers 9 within the container 1 or the container wall 3.

It is highly preferred that the at least one partition wall 8 is connected in one piece or integrally with the carrier 10 or the center part 13 of the carrier 10. It is advantageous for the tube 6 to be connected in one piece and preferably integrally to the carrier 10 or the center part 13 of the carrier 10. It is preferable for the filler neck 20 or the filler opening 19 to be connected in one piece and preferably integrally to the carrier 10 or the center part 13 of the carrier 10.

By removing the second side part 15 and simultaneously omitting the first side part 14, the second side of the center part 13 is visible in FIG. 4 from the perspective of FIG. 3. A container base contour 27 for connection to the second side part 15 is preferably arranged on the second side of the center part 13. It is advantageous that the container 1 comprises a container outlet 29. The container outlet 29 is preferably arranged in a lower region of the container 1 and in particular at the container base 28.

It is highly preferred that the container base contour 27 of the center part 13 is interrupted at one point in order to form a channel 11 for providing the container outlet 29, or transitions into a channel contour 24. FIG. 4 shows in particular that the tube 6 or the connected end 22 of the tube 6 is preferably connected fluidically to several connections or connectors 16. It is preferable that the tube 6 is connected fluidically via the connected end 22 to one channel 11 or several channels 11 of the carrier 10. FIG. 4 also shows that the center part 13 can completely form a channel 11, see the channel 11 at the bottom right in FIG. 4 in comparison with FIG. 2.

FIG. 5 shows a cross-section through the assembly 2, 17, 25, wherein a line L indicates that the sections through the heat exchanger 17 and the pump 25 are offset relative to each other, cf, the sections symbolized by the dotted line in FIG. 3. FIG. 5 shows in particular that the center part 13, the first side part 14, and the second side part 15 form the base body 32 of the carrier 10, the container 1, and the module 2, respectively. This three-layer arrangement allows the module 2, the carrier 10, and the container 1 to be designed in great detail.

FIG. 5 shows that, in this embodiment, the first side part 14 is assigned to the heat exchanger 17, whereas the second side part 15 is assigned to the pump 25. Both the first side part 14 and the second side part 15 of this embodiment form channels 11. The breakthrough 26 preferably corresponds to the heat exchanger 17. FIG. 5 also shows sensors or electronic elements, which are not described further here, which are arranged between the heat exchanger 17 and the pump 25.

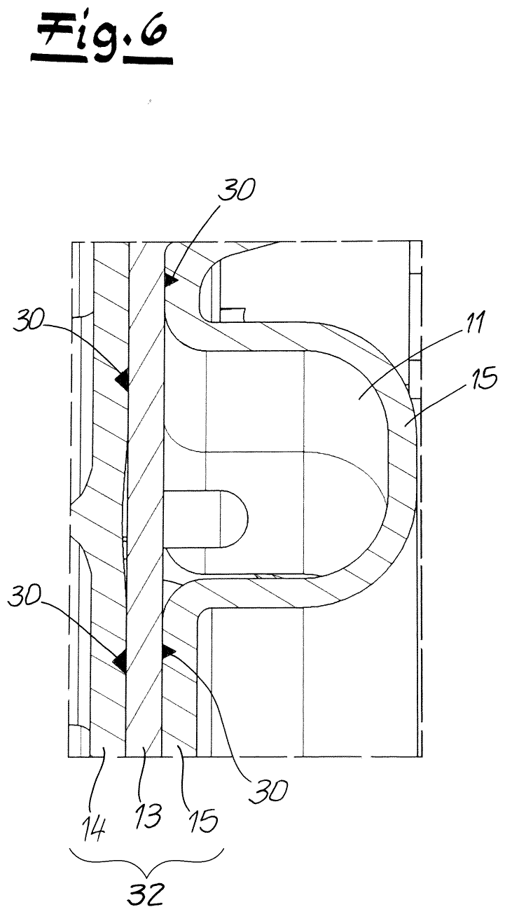

FIG. 6 shows an enlarged section of the module 2 or the carrier 10 from FIG. 5. Weld seams 30 are provided to seal the channel 11 formed by the second side part 15 and the center part 13. It is preferable that the weld seams 30 of the channels 11 are created by melting channel contours 24, preferably by blow molding. In FIG. 6, the first side part 14 and the center part 13 are also connected by weld seams 30, which are preferably formed by melting contours of the center part 13 by blow molding.

### LIST OF REFERENCE SIGNS

1 Container
2 Module
3 Container wall
4 Container lumen
5 Inner element
6 Tube
7 Free end of 6
8 Partition wall
9 Container chamber
10 Carrier
11 Channel
12 Receptacle
13 Center part
14 First side part
15 Second side part
16 Connector
17 Heat exchanger
18 Container lid
19 Filler opening
20 Filler neck
21 Holder for level sensor
22 Connected end of 6
23 Connection element of 10 for 6
24 Channel contour
25 Pump
26 Breakthrough
27 Container base contour of 13
28 Container base
29 Container outlet
30 Weld seam
31 Upper section of 10
32 Base body made of 13, 14, 15

1. A container for a module of a temperature control medium circuit, wherein the container has a container wall, wherein the container wall encloses a container lumen that can be filled with the temperature control medium, and wherein the container has an inner element, wherein the inner element is at least partially enclosed by the container wall or is arranged in the container lumen.

2. The container according to claim 1, wherein the inner element comprises a tube, wherein preferably the tube has a free end, wherein it is preferred that the free end of the tube opens into the upper two-thirds or the upper half or the upper third of the container lumen.

3. The container according to claim 1, wherein the inner element or the container has at least one partition wall, wherein the partition wall divides the container lumen into at least two container chambers, wherein the container chambers are connected to each other in a fluidic manner.

4. A module for a temperature control medium circuit, wherein the module comprises the container according to claim 1, and further comprising a carrier, wherein the carrier has at least one channel, wherein the carrier comprises at least one receptacle for arranging at least one fluid component, wherein the carrier has a center part, a first side part and a second side part, and wherein the container is formed by the center part, the first side part and/or the second side part.

5. The module according to claim 4, wherein the center part is formed in one piece and integrally, wherein the center part is manufactured by injection molding.

6. The module according to claim 5, wherein the first side part and/or the second side part is/are formed in one piece and integrally, wherein the first side part and/or the second side part is/are manufactured by blow molding.

7. The module according to claim 4, wherein the center part comprises at least one section of the inner element of the container and/or at least one part of a receptacle and/or at least one cross-sectional portion of a channel.

8. An assembly for a temperature control medium circuit, comprising a module according to one of claim 4, wherein at least one fluid component is arranged on the carrier of the module.

9. Use of a container according to claim 1, for an electrical system for an electric vehicle having a drive battery of the vehicle.

10. A method for manufacturing a module for a temperature control medium circuit according to claim 4, wherein the module comprises a container and a carrier, wherein the container has a container wall, wherein the container wall encloses a container lumen that can be filled with the temperature control medium, wherein the container has an inner element, wherein the inner element is at least partially enclosed by the container wall or is arranged in the container lumen, and wherein the first side part and/or the second side part is/are produced by blow molding.

11. The method according to claim 10, wherein the center part is arranged between the first side part and the second side part during blow molding of the first side part and/or the second side part.

12. The method according to claim 10, wherein the center part is connected by material-bonding or welded to the first side part and/or the second side part during blow molding of the first side part and/or the second side part.
